(19) United States
(12) Patent Application Publication
(10) Pub. No.: US 2014/0052523 A1
(43) Pub. Date: Feb. 20, 2014

(54) Systems and Methods for Mutually Promoting Fundraising Organizations and Merchants

(71) Applicant: Tag-Town, LLC, Atlanta, GA (US)

(72) Inventors: John R. Adams, Atlanta, GA (US); Joseph Raymond Monroe, Atlanta, GA (US)

(73) Assignee: Tag-Town, LLC, Atlanta, GA (US)

(21) Appl. No.: 13/968,075

(22) Filed: Aug. 15, 2013

Related U.S. Application Data
(60) Provisional application No. 61/683,522, filed on Aug. 15, 2012.

(51) Int. Cl. G06Q 30/02

(52) U.S. Cl. CPC G06Q 30/0225; G06Q 30/0233
USPC 705/14.26

(57) ABSTRACT

The disclosure includes systems and methods for promoting fundraising organizations and merchants. In one embodiment, a method can be provided. The method can include receiving an indication a merchant-associated tag was scanned by a tag reader via a processor-based device at a merchant location; validating the merchant-associated tag and scanning event; and providing an incentive to a beneficiary based at least in part on the validation of the merchant-associated tag and the scanning event.

### RELATED APPLICATION

The present disclosure claims priority to U.S. Ser. No. 61/683,522, titled “Systems and Methods for Mutually Promoting Fundraising Organizations and Merchants,” filed on Aug. 15, 2012, the contents of which are hereby incorporated by reference.

### TECHNICAL FIELD

The disclosure generally relates to loyalty, and more particularly relates to systems and methods for mutually promoting fundraising organizations and merchants.

### BACKGROUND OF THE DISCLOSURE

Conventional loyalty programs involving customers and retail merchants are typically difficult to administer and implement. Some loyalty programs may require lengthy written applications for customers to apply, which includes disclosure of personal and financial information. Other loyalty programs may require customers to consistently carry an identification card or loyalty number, which can be misplaced or otherwise forgotten by customers.

### BRIEF SUMMARY OF THE DISCLOSURE

According to example embodiments of the disclosure, systems and methods for mutually promoting fundraising organizations and merchants are described herein.

As used herein, a “beneficiary” is defined as a fundraising organization, a charity, or a group or entity for which funds are raised for the benefit of the group or entity. Examples of a beneficiary can include, but are not limited to, booster clubs, charities, non-profit organizations, civic organizations, and schools.

In one embodiment, a method can be provided. The method can include receiving an indication a merchant-associated tag was scanned by a tag reader via a processor-based device at a merchant location; validating the merchant-associated tag and scanning event; and providing an incentive to a beneficiary based at least in part on the validation of the merchant-associated tag and the scanning event.

In another embodiment, a system can be provided. The system can include a processor operable to execute computer-executable instructions stored in at least one memory. The at least one memory can be operable to receive an indication a merchant-associated tag was scanned by a tag reader via a processor-based device at a merchant location; validate the merchant-associated tag and scanning event; and provide an incentive to a beneficiary based at least in part on the validation of the merchant-associated tag and the scanning event.

In yet another embodiment, one or more computer-readable media can be provided. The one or more computer-readable media can store computer-executable instructions that, when executed by at least one processor, configure the at least one processor to receive an indication a merchant-associated tag was scanned by a tag reader via a processor-based device at a merchant location; validate the merchant-associated tag and scanning event; and provide an incentive to a beneficiary based at least in part on the validation of the merchant-associated tag and the scanning event.

Other embodiments, systems, methods, and aspects of the disclosure are described in detail herein and are considered a part of the disclosure. Other embodiments and aspects can be understood with reference to the following figures and detailed description.

### BRIEF DESCRIPTION OF THE FIGURES

FIG. 1 depicts an example data flow according to an embodiment of the disclosure.

FIG. 2 illustrates an example system according to an embodiment of the disclosure.

FIGS. 3-6 illustrate example screenshots for an example system and example method according to embodiments of the disclosure.

FIG. 7 illustrates an example method according to an embodiment of the disclosure.

FIG. 8 illustrates other example methods according to an embodiment of the disclosure.

### DETAILED DESCRIPTION

According to example embodiments of the disclosure, systems and methods for mutually promoting organizations and merchants are described herein. These and other embodiments of the disclosure will be described more fully herein. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

In one embodiment of the disclosure, the financial interests of fundraising organizations, or beneficiaries, and retail merchants can be mutually promoted. A host entity can register one or more fundraising organizations and retail merchants to participate in a tag community program. Members of the one or more participating fundraising organizations can be encouraged to purchase goods and/or services from the participating retail merchants. Based at least in part on a particular retail merchant's revenue, sales, and/or consumer traffic, the host entity can pay an incentive to one or more of the participating fundraising organizations. An incentive can include, but is not limited to, a monetary payment, a discount or reduction in a fee, a loyalty or reward point allocation, or any other monetary or social benefit. In one example, an incentive can be monetary compensation based at least in part on a merchant's actual revenue, sales, consumer traffic, or combination thereof.

In certain embodiments of the disclosure, registering and tracking mobile communication devices can be facilitated. Using an example system and methods described herein, any number of mobile communication devices can be associated with one or more specific fundraising organizations or beneficiaries. When a consumer wants to affiliate himself or herself with a particular fundraising organization or beneficiary, the consumer can read a scannable tag associated with the fundraising organization or beneficiary, or otherwise select the fundraising organization or beneficiary using a mobile communication device associated with the consumer. Information associated with the scannable tag associated with the fundraising organization or beneficiary, or the consumer's selection, can be transmitted to a host entity, and the consumer and associated mobile communication device can be registered to “follow” or otherwise be associated with the fundraising organization or beneficiary. Subsequent activity of the mobile communication device and the consumer associated with the mobile communication device can be recorded and tracked when the consumer reads a scannable tag, associated with at least one retail merchant or other revenue-based entity, using the mobile communication device. When the consumer reads a scannable tag associated with at least one retail merchant or other revenue-based entity, the consumer and associated mobile communication device can be registered to “follow” or otherwise be associated with a beneficiary, which in turns allows the user to “follow” or otherwise be associated with retail merchants or revenue-based entities associated with the beneficiary. The host entity can store, manage, and/or process some or all of the associations using a host server and/or data storage device.

In other embodiments of the disclosure, tracking retail and shopping experiences can be facilitated. When a consumer visits a participating retail merchant or other revenue-based entity, the consumer reads a scannable tag, associated with at least one retail merchant or other revenue-based entity, using the mobile communication device. The host entity can monitor and record the number, frequency, and time of consumer retail visits; consumer traffic involving multiple consumers; and participation by consumers in any number of events associated with a retail merchant or other revenue-based entity. The host entity can store, manage, and/or process some or all of the associated information, and can provide or otherwise make available the information to interested merchants and entities by way of online access, email, and/or printed reports.

In other embodiments of the disclosure, registration of a consumer in a fundraising campaign can be facilitated. When a consumer uses a mobile communication device to scan a scannable tag associated with at least one retail merchant or other revenue-based entity, a host server can determine whether the consumer's mobile communication device is registered with any fundraising organization or beneficiary. The host server can initially check whether the retail merchant or other revenue-based entity is associated with only one fundraising organization or beneficiary. If so, the host server can automatically associate the consumer's mobile device with that fundraising organization or beneficiary. The host server can store the association for subsequent processing, and the consumer's mobile device can be configured accordingly. If the retail merchant or other revenue-based entity is not associated with any fundraising organization or beneficiary, or in some instances, is associated with multiple fundraising organizations or beneficiaries, the host server can provide instructions and/or commands via the consumer's mobile communication device to prompt the consumer to select at least one fundraising organization or beneficiary associated with the retail merchant or other revenue-based entity.

In certain embodiments, various revenue models can be implemented. For example, one or more retail merchants can be charged at varying rates for participating in a fundraising campaign. In another example, loyalty points can be accumulated for redemption after purchasing certain goods and/or services from participating retail merchants.

In certain embodiments, advertisements and/or announcements can be output to the members' processor-based devices. For example, paid advertisements by certain retail merchants can be prominently displayed, maps and/or links to nearby participating retail merchants can be displayed, and “gold star” promotions from certain retail merchants can be displayed.

In certain embodiments, one or more reports can be provided to participating fundraising organizations, beneficiaries, and/or retail merchants with suggestions, recommendations, and/or best practices to increase incentives, sales, revenue, and customer traffic. In some instances, communications can be facilitated between participating fundraising organizations or beneficiaries, or between participating merchants to coordinate advertisements, announcements, or other mutually beneficial initiatives.

Thus, using some or all of the embodiments of the disclosure, consumers' loyalty to participating fundraising organizations or beneficiaries can be used to mutually benefit the participating fundraising organizations or beneficiaries, and retail merchants. In this manner, a technical solution to mutually benefitting participating fundraising organizations or beneficiaries, and retail merchants can be implemented.

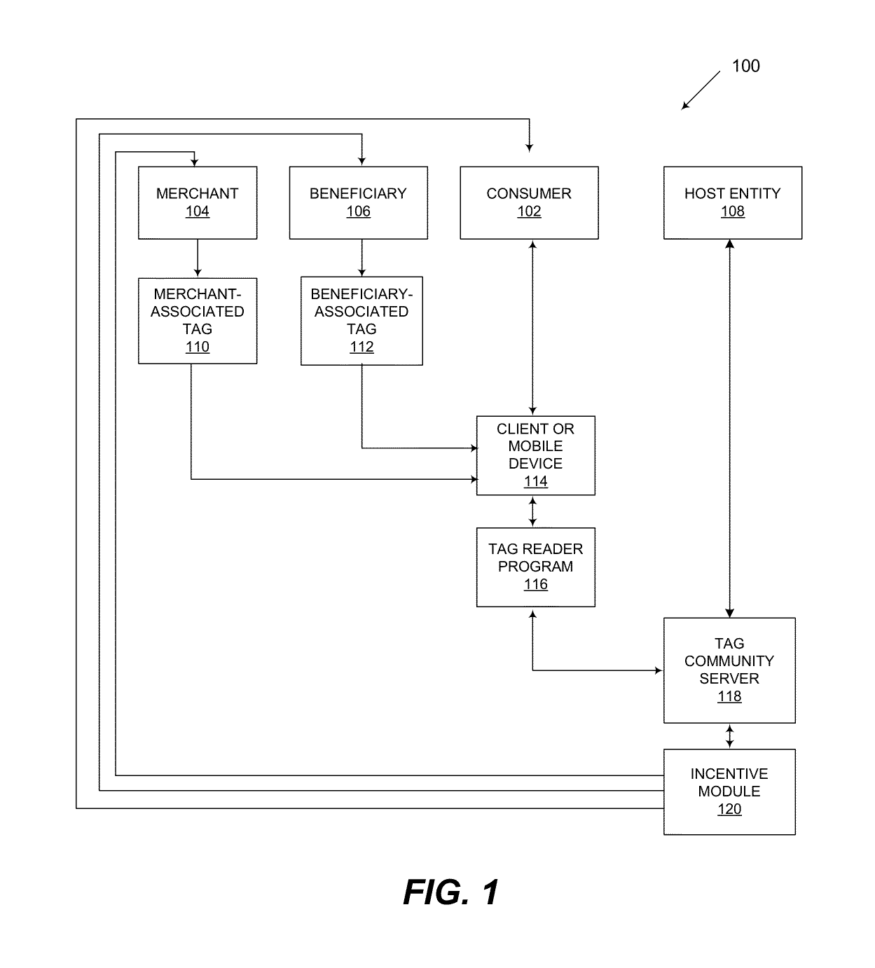

An example data flow 100 according to an embodiment of the disclosure is shown in FIG. 1. In FIG. 1, the data flow 100 can include various communications between a consumer 102, merchant 104, a beneficiary 106, and a host entity 108. Scannable tags, such as a merchant-associated tag 110 and a beneficiary-associated tag 112, can be used to facilitate certain communications and/or transactions between entities. When the consumer 102 visits a location of a merchant 104, the consumer 102 can operate a client-type device or mobile device, such as 114, to execute a tag reader application program 116. The tag reader application program 116 can be used to scan, view, or otherwise read information from the scannable tags 110, 112. Each of the scannable tags 110, 112 may be respectively associated with the merchant 104 and beneficiary 106. Information from the scannable tags 110, 112 can be transmitted by the program 116 to a tag community server 118 or host server for processing. An incentive module 120 associated with the tag community server 118 or host server can execute a set of instructions to monitor, track, and/or provide incentives to the consumer 102, merchant 104, and/or beneficiary 106 when the consumer 102 visits the merchant 104 and performs certain activities requiring the scannable tags 110, 112 to be scanned, viewed, or otherwise read by the consumer 102.

In one embodiment, for example, using a client-type device or mobile device 114, a consumer 102 may preselect a participating beneficiary, such as 106, by scanning or otherwise selecting a beneficiary-associated tag 112. Likewise, a participating merchant 104 may decide to display or otherwise provide a scannable tag, such as a merchant-associated tag 110. When the consumer 102 visits the merchant 104, the consumer 102 can read the merchant-associated tag 110 using the tag reader application program 116 and/or the client-type device or mobile device 114. The incentive module 120 can receive an indication the consumer 102 visited a particular merchant 104 by way of receiving information from the merchant-associated tag 110 via the tag reader application program 116 and/or the client-type device or mobile device 114. The incentive module 120 can provide an incentive to respective accounts associated with the beneficiary 106 as well as the consumer 102 and/or merchant 104.

In another embodiment, the incentive module 120 can record any number of visits to and participation in other activities by the consumer 102 at one or more merchants, such as 104. For each visit and/or respective activity, the incentive module 120 can provide an incentive to one or more accounts associated with a beneficiary 106 as well as the consumer 102 and/or merchant 104.

In yet another embodiment, the incentive module 120 can associate any number of merchants, such as 104, with any number of beneficiaries, such as 106. In one example, an incentive module 120 can associate a particular beneficiary 106 with multiple merchants, such as 104. The beneficiary 106 can be assigned a unique scannable tag, such as 112. Likewise, the merchants, such as 104, can be assigned respective unique scannable tags, such as 110. The incentive module 120 can then associate the beneficiary-associated tag 112 with one or more merchant-associated tags, such as 110, and store the associations for future retrieval and processing.

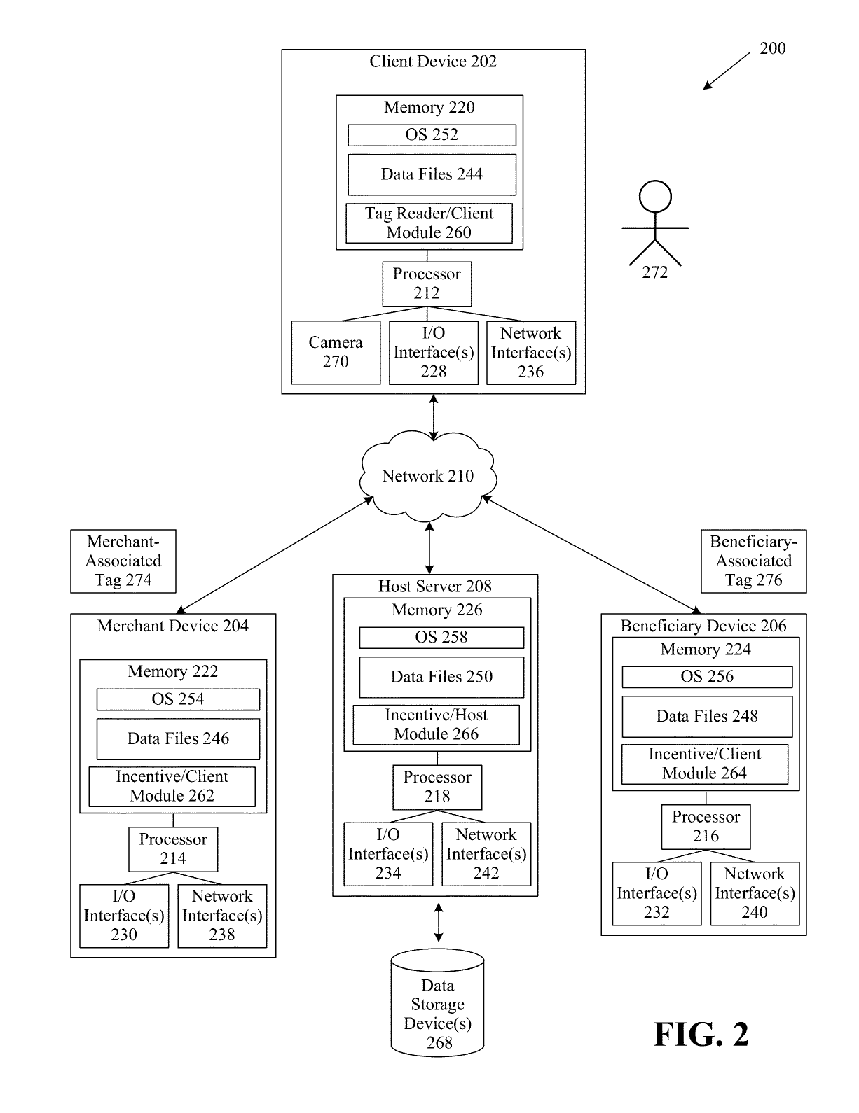

Turning to FIG. 2, an example system 200 for mutually promoting organizations and merchants is illustrated according to an embodiment of the disclosure. In the embodiment shown in FIG. 2, a client device 202, a merchant device 204, a beneficiary device 206, and a host server 208 may all communicate with each other via at least one network 210. Each of the client device 202, merchant device 204, beneficiary device 206, and host server 208 may be one or more processor-driven devices, such as, but not limited to, a mobile device, a mobile communication device, a smart phone, a mobile phone, a tablet, a server computer, a personal computer, a laptop computer, a handheld computer, a wearable computer, and the like. The network 210 shown can link the client device 202, merchant device 204, beneficiary device 206, and host server 208 together, wherein the network can include one or more wired or wireless networks. In addition to having one or more processors 212, 214, 216, 218, the client device 202, merchant device 204, beneficiary device 206, and host server 208 may each further include one or more memories 220, 222, 224, 226, one or more input/output (I/O) interfaces 228, 230, 232, 234, and one or more network interfaces 236, 238, 240, 242, respectively. The memories 220, 222, 224, 226 may store data files 244, 246, 248, 250 and various program modules, such as an operating system (OS) 252, 254, 256, 258, a client and/or host module 260, 262, 264, 266, which may include functionality for accessing one or more databases, such as 268. The I/O interfaces 228, 230, 232, 234 may facilitate communication between the processors 212, 214, 216, 218, respectively, and various I/O devices, such as a camera, range finder, laser range finder, bar code reader/scanner, RFID reader, NFC reader, machine readable item reader, scanner, tag reader, keyboard, mouse, printer, microphone, speaker, monitor, display screen, touch screen, and the like. The network interfaces 236, 238, 240, 242 each may take any of a number of forms, such as a network interface card, a modem, a wireless network card, and the like.

With reference to the client device 202, which may be or include a mobile device or personal computer, the tag reader/client module 260 may be an Internet browser or other software, such as a tag reader application program or app, for interacting with the merchant device 204, beneficiary device 206, and/or host server 208. For example, a camera, such as 270, associated with the client device, such as 202, may interface with the tag reader/client module 260 via the I/O interface 228, wherein the tag reader/client module 260 can provide suitable functionality to read or scan a scannable tag. A user or consumer, such as 272, may then utilize the tag reader/client module 260 to read, scan, or otherwise obtain information from the scannable tag, such as a merchant-associated tag 274 and/or a beneficiary-associated tag 276. In some embodiments, the tag reader/client module 260 can interact with the incentive/host module 266 of the host server 208 to perform one or more of the functions associated with the tag reader/client module 260. In some embodiments, some or all of the functionality of the tag reader/client module 260 can be performed by the incentive/host module 266 of the host server 208.

The tag reader/client module 260 and/or the incentive/host module 266 may include computer-executable instructions operable to receive information associated with one or more merchant devices 204 and/or beneficiary devices 206, such as information associated with a merchant-associated tag 274 and/or a beneficiary-associated tag 276. The tag reader/client module 260 and/or the incentive/host module 266 may also include computer-executable instructions operable to facilitate transmitting information from the tag reader/client module 260 to the incentive/host module 266 for storage and subsequent processing.

In certain embodiments, a merchant-associated tag can include, but is not limited to, at least one of the following: a bar code, a 2D bar code, a Microsoft™ Tag, a QR code, or an alphanumeric code. In certain embodiments, a beneficiary-associated tag can include, but is not limited to, at least one of the following: a bar code, a 2D bar code, a Microsoft™ Tag, a QR code, or an alphanumeric code. In one example embodiment, a merchant-associated tag and/or beneficiary-associated tag can both be respective Microsoft™ Tags which can be read by a Microsoft™ Tag reader. In some embodiments, a tag reader/client module 260 and/or the incentive/host module 266 can computer-executable instructions operable to provide a unique identifier of a client device that read or scanned the scannable tag.

In some embodiments, the tag reader/client module 260 and/or the incentive/host module 266 may include computer-executable instructions operable to receive an indication a merchant-associated tag was scanned by a tag reader via a processor-based device at a merchant location, validate the merchant-associated tag and scanning event, and provide an incentive to a beneficiary based at least in part on the validation of the merchant-associated tag and the scanning event.

In some embodiments, the tag reader/client module 260 and/or the incentive/host module 266 may include computer-executable instructions operable to output fundraising campaign information to a processor-based device.

In some embodiments, the tag reader/client module 260 and/or the incentive/host module 266 may include computer-executable instructions operable to compare geo-location information received from the processor-device with previously stored location information associated with the merchant.

In some embodiments, the tag reader/client module 260 and/or the incentive/host module 266 may include computer-executable instructions operable to provide a respective scannable tags to a merchant and to a beneficiary, wherein the scannable tags uniquely identify the merchant and the beneficiary.

In some embodiments, the tag reader/client module 260 and/or the incentive/host module 266 may include computer-executable instructions operable to provide a downloadable application for a processor-based device, wherein the application comprises the tag reader.

In some embodiments, the tag reader/client module 260 and/or the incentive/host module 266 may include computer-executable instructions operable to receive an indication a beneficiary-associated tag was scanned by a tag reader via the processor-based device, and associate the processor-based device with the beneficiary.

At the host server 208, merchant device 204, and/or beneficiary device 206, one or more inputs from a consumer 272 operating a client device 202 can be received via the tag reader/client module 260 and/or the incentive/host module 266 to select at least a first product recipe and at least a second product recipe.

One will recognize that in other embodiments each of the tag reader/client module 260, incentive/client module 262, incentive/client module 264, and incentive/host module 266 may include other computer-executable instructions to perform similar functionality or operations to that described above. It is appreciated that, in example embodiments, the modules 260, 262, 264, 266 may be provided in part or entirely within the respective client device 202, merchant device 204, beneficiary device 206, and host server 208, or may be included as a separate computer device and in operable communication with the respective client device 202, merchant device 204, beneficiary device 206, and host server 208. In yet other embodiments, the respective client device 202, merchant device 204, beneficiary device 206, and host server 208 may be provided in part or entirely within one or more of the other entities' systems.

The data storage device 268 is represented as single data storage device for simplicity. It is appreciated, however, that multiple physical and/or logical data storage devices or databases may be used to store the above mentioned data. For security and performance purposes, each of the merchant device 204, beneficiary device 206, and host server 208 may have a dedicated connection to the data storage device 268. However, each of the client device 202, merchant device 204, beneficiary device 206, and host server 208 may also communicate with the data storage device 268 via the network 210 shown, or via another network. According to other embodiments, the merchant device 204, beneficiary device 206, and host server 208 may include the data storage device 268 locally, or may include respective data storage devices, similar to 268, locally. Each of the merchant device 204, beneficiary device 206, and host server 208 may also be part of a distributed or redundant DBMS.

It is appreciated that each of the memories and data storage devices described herein for each of the client device 202, merchant device 204, beneficiary device 206, and host server 208 can store data and information for subsequent retrieval. The memories and data storage devices can be in communication with each other and/or with other data storage devices, such as a centralized database, or other types of data storage devices. When needed, data or information stored in a memory or a data storage device may be transmitted to a centralized database capable of receiving data, information, or data records from more than one database or other data storage devices. In other embodiments, the data storage devices shown can be integrated or distributed into any number of databases or other data storage devices.

The network 210 may include any number of telecommunication and/or data networks, whether public, private, or a combination thereof, including a local area network, a wide area network, a publicly switched telephone network (PSTN), an intranet, the Internet, intermediate handheld data transfer devices, and/or any combination thereof, and may be wired and/or wireless. The network 210 may also include a product and/or promotion transaction network for processing real-time, off-line, and/or batch transactions to be transmitted between the client device 202, merchant device 204, beneficiary device 206, and host server 208. Due to network connectivity, various methodologies as described herein may be practiced in the context of distributed computing environments. Although the system 200 is shown for simplicity as including one intervening network, such as 210, it is to be understood that any other network configuration is possible. For example, an intervening network, such as 210, may include a plurality of networks, each with devices such as gateways and routers, for providing connectivity between or among the networks. Instead of or in addition to a network 210, dedicated communication links may be used to connect the various devices in accordance with an example embodiment of the disclosure.

In some embodiments, merchant device 204, beneficiary device 206, and host server 208, may be a single service provider computer. One will recognize the applicability of other example embodiments of the disclosure to more than two computers or servers.

The system 200 shown in FIG. 2 is provided by way of example only. One will recognize that other embodiments can include other client devices, product dispensers, and servers within the system 200. Numerous other operating environments, system architectures, and device configurations with fewer or greater numbers of components are possible. Accordingly, embodiments of the invention should not be construed as being limited to any particular operating environment, system architecture, or device configuration.

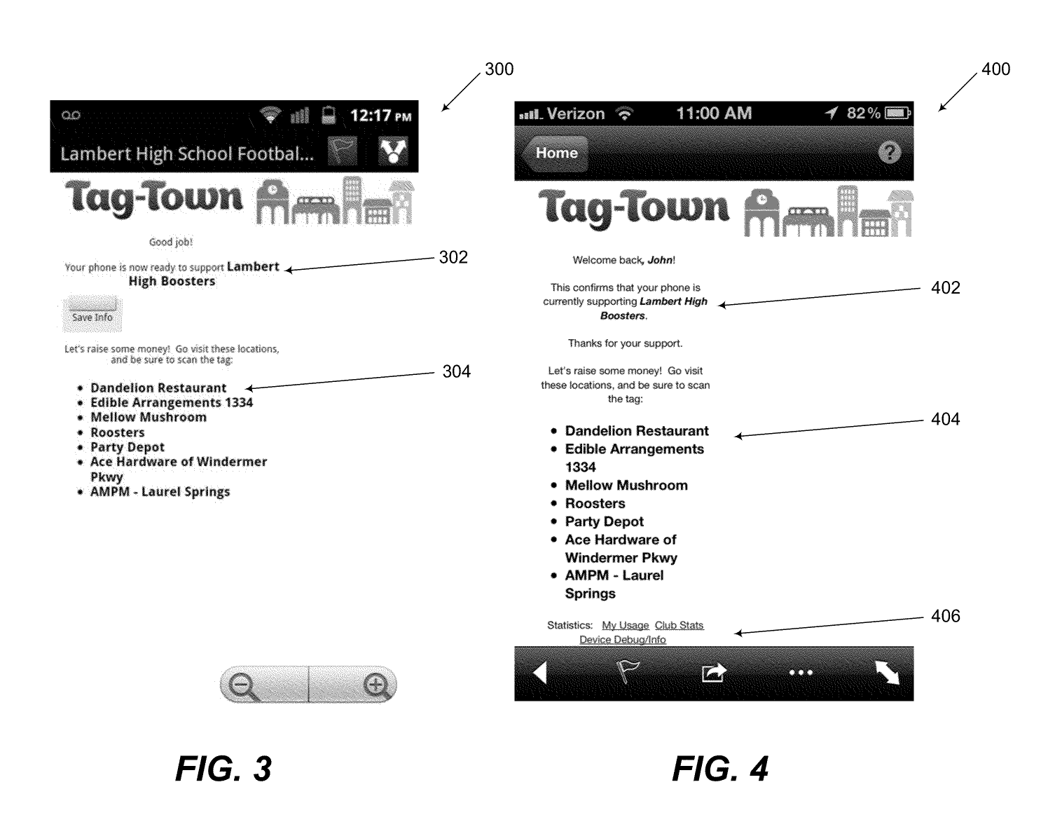

FIGS. 3-6 illustrate example screenshots for an example system and example method according to embodiments of the disclosure. FIGS. 3 and 4 show example user interfaces 300, 400 for a client device, such as 114 in FIG. 1, associated with a consumer, such as 102. The interfaces 300, 400 can indicate previous selection 302, 402 by the consumer 102 of a particular beneficiary, such as 106, wherein the client device 114 is associated with the beneficiary 106. The consumer 102 can view a list 304, 404 of one or more participating retail merchants, each similar to 104. When the consumer 102 visits any of the participating retail merchants, such as 104, the consumer 102 can use the client device 114 to read a scannable tag at the retail merchant 104. In certain instances, such as in FIG. 4, a consumer 102 can view statistics and/or other information 406 associated with his or her usage, beneficiary information, and/or the client or mobile device.

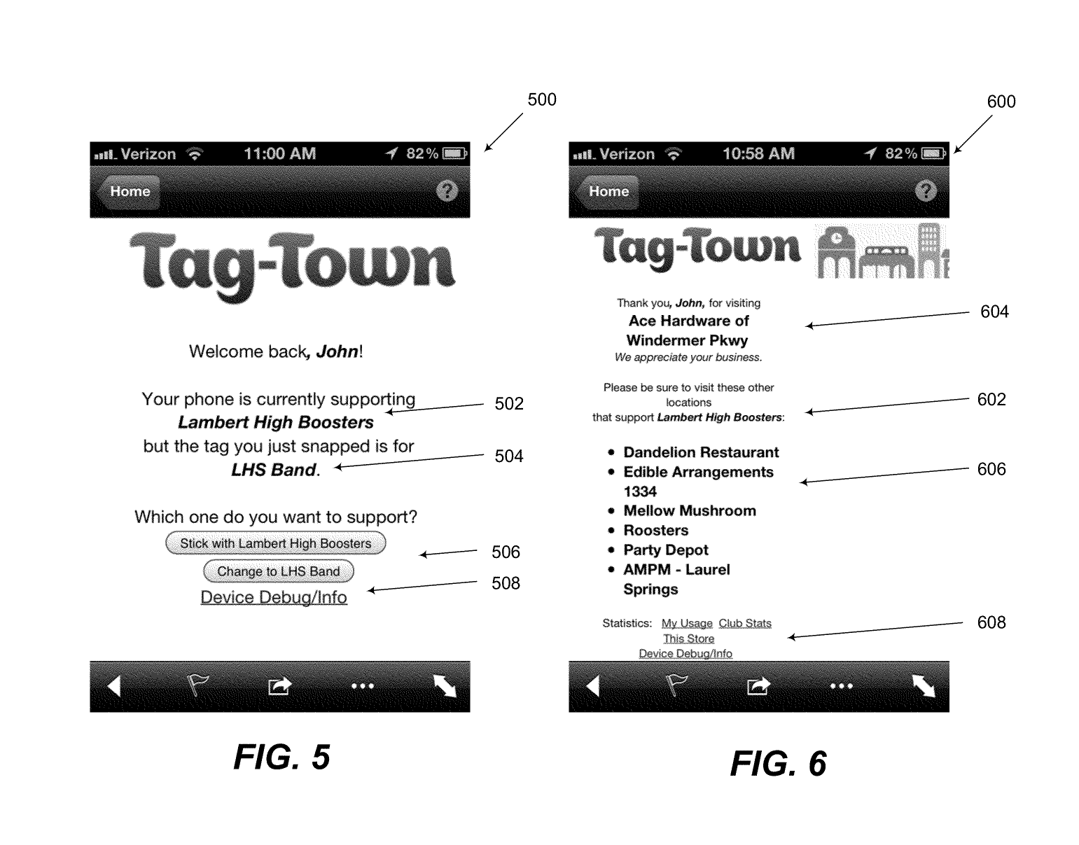

FIG. 5 shows another example user interface 500 for a client device, such as 114 in FIG. 1, associated with a consumer, such as 102. The interface 500 can indicate a previous selection 502 by the consumer 102 of a particular beneficiary, such as 106, wherein the client device 114 is associated with the beneficiary 106. In this example, the consumer 102 may try to associate the client device 114 with another beneficiary 504, and the user interface 500 can prompt the consumer 114 with one or more instructions and/or commands, such as 506, to keep the existing beneficiary 502 or change to a newly, recently selected, or other beneficiary 504. In certain instances, such as in FIG. 4, a consumer 102 can view statistics and/or other information 508 associated the client or mobile device.

FIG. 6 shows yet another example user interface 600 for a client device, such as 114 in FIG. 1, associated with a consumer, such as 102. The interface 600 can indicate a previous selection 602 by the consumer 102 of a particular beneficiary, such as 106, wherein the client device 114 is associated with the beneficiary 106. The interface 600 can also indicate a recent consumer visit to a location of a participating retail merchant, such as 104, by identifying the merchant 604 and acknowledging the consumer's visit. The consumer 102 can view a list 604 of one or more other participating retail merchants, each similar to 104. When the consumer 102 visits any of the participating retail merchants, such as 104, the consumer 102 can use the client device 114 to read a scannable tag at the retail merchant 104. In certain instances, such as in FIG. 6, a consumer 102 can view statistics and/or other information 608 associated with his or her usage, beneficiary information, merchant information, and/or the client or mobile device.

Other user interface examples can be output by other embodiments of the disclosure, and the user interfaces illustrated herein are by way of example only.

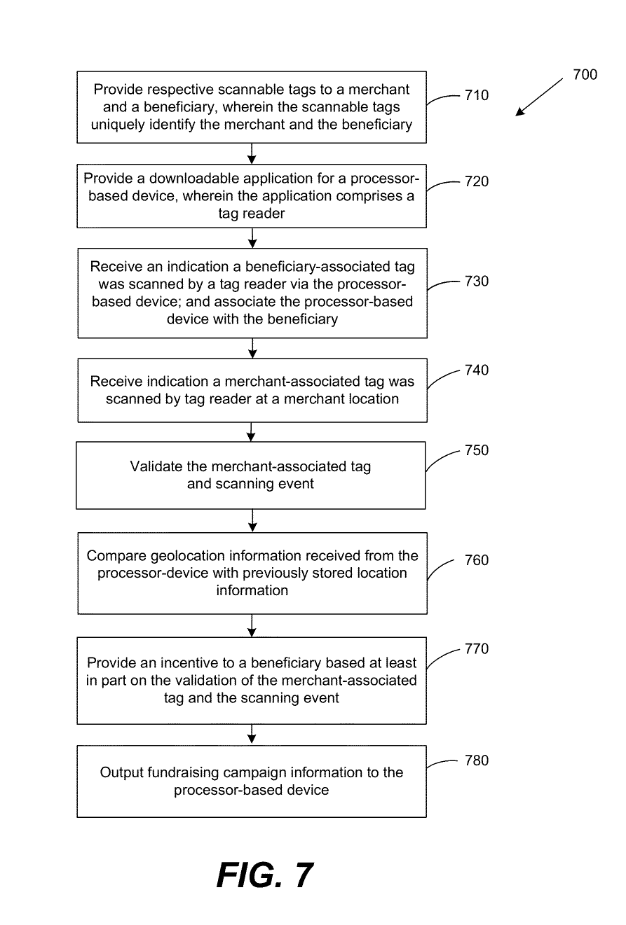

FIG. 7 illustrates an example method 700 according to an embodiment of the disclosure. The method 700 begins at block 710. In block 710, respective scannable tags can be provided to a merchant and a beneficiary, wherein the scannable tags uniquely identify the merchant and the beneficiary. In this embodiment, a host entity, such as 108 in FIG. 1, and/or host server, such as 208 in FIG. 2, can provide, generate, select, or otherwise assign respective scannable tags to at least one merchant, such as merchant 104, and to at least one beneficiary, such as beneficiary 106. For example, the host server 208 can generate respective scannable tags for the merchant 104 and the beneficiary 106. The merchant 104 can be provided a merchant-associated tag, such as 274, and the beneficiary 106 can be provided a beneficiary-associated tag, such as 276. The scannable tags can be provided by the host server 208 to a merchant device 204 associated with the merchant 104, and to a beneficiary device 206 associated with the beneficiary 106, by way of online access, email, and/or printed output.

Block 710 is followed by optional block 720, in which a downloadable application is provided for a processor-based device, wherein the application includes a tag reader. In this embodiment, a host entity 108, a merchant 104, and/or a beneficiary 106, can provide a downloadable application such as a tag reader. The downloadable application may be accessed by a client device, such as 202, associated with a consumer 102, and subsequently stored on or executed by the client device 202.

Block 720 is followed by block 730, in which an indication is received that a beneficiary-associated tag was scanned by a tag reader via the processor-based device, and the processor-based device is associated with the beneficiary. In this embodiment, a host entity 108 and/or incentive/host module, such as 266, can receive a communication from a tag reader/client module, such as 260, associated with a client device, such as 202, after a beneficiary-associated tag, such as 276, is read or otherwise scanned by the client device 202, and the tag reader/client module 260 receives information associated with the beneficiary-associated tag 276. Upon or after receipt of the communication, the host entity 108 and/or incentive/host module 266 can associate the client device 202 with the beneficiary, such as 106, associated with the beneficiary-associated tag 276.

Block 730 is followed by optional block 740, in which 1 n indication is received a merchant-associated tag was scanned by a tag reader at a merchant location. In this embodiment, a host entity 108 and/or incentive/host module, such as 266, can receive a communication from a tag reader/client module, such as 260, associated with a client device, such as 202, after a merchant-associated tag, such as 274, is read or otherwise scanned by the client device 202, and the tag reader/client module 260 receives information associated with the merchant-associated tag 274.

Block 740 is followed by block 750, in which the merchant-associated tag and scanning event are validated. In this embodiment, a host entity 108 and/or incentive/host module 266 can validate the merchant-associated tag 274 and scanning event. Validation can include decryption of information stored in the tag, comparing the tag and/or associated information to previously stored information, and/or checking or comparing transaction information, not limited to geolocation information, merchant information, consumer information and/or client device information.

Block 750 is followed by optional block 760, in which geolocation information received from the processor-device can be compared to location information associated with the previously stored location information. In this embodiment, a host entity 108 and/or incentive/host module 266 can receive geolocation information from the client device 202 and/or tag reader/client module 260, and the geolocation information can be compared to previously stored location information associated with the merchant 104.

Block 760 is followed by block 770, in which an incentive to a beneficiary can be provided based at least in part on validation of the merchant-associated tag and the scanning event. In this embodiment, during or after validation of the merchant-associated tag and the scanning event, the host entity 108 and/or incentive/host module 266 can generate or otherwise provide an incentive to a beneficiary, such as 106, associated with the merchant 104 and/or client device 202. The host entity 108 and/or incentive/host module 266 can allocate the incentive to one or more accounts associated with the beneficiary 106. In certain embodiments, the one or more accounts may be managed and/or accessible by the same or different entities.

Block 770 is followed by optional block 780, in which fundraising campaign information can be output to the processor-based device. In this embodiment, the host entity 108 and/or incentive/host module 266 can output or otherwise send information associated with a fundraising campaign to a consumer 102 via the client device 202 and/or tag reader/client module 260 associated with the client device 202. The fundraising information can include, but is not limited to, statistical information, incentive allocations and/or amounts, beneficiary information, and advertising.

The method 700 ends after block 780.

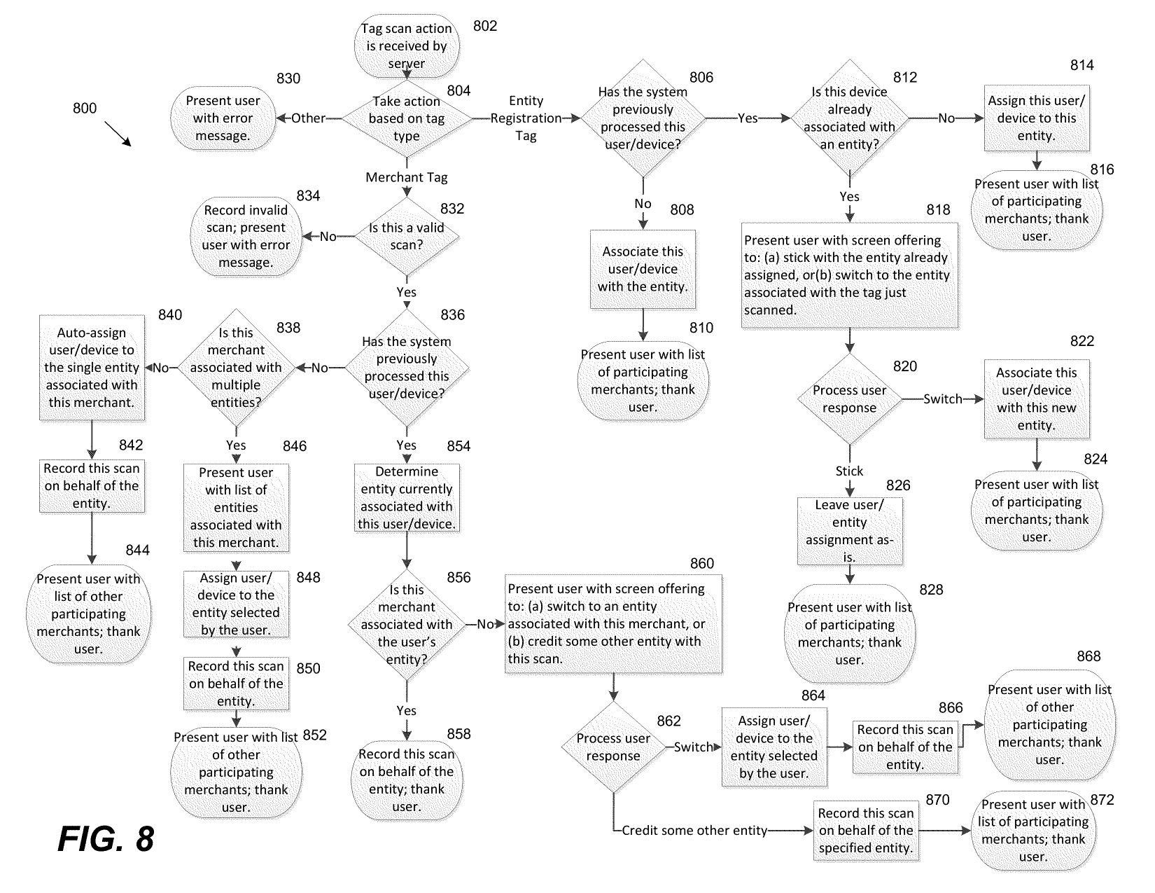

FIG. 8 illustrates other example methods according to an embodiment of the disclosure. The method 800 begins at block 802. In block 802, a tag scan action is received by the host server. Block 802 is followed by decision block 804, in which an action is taken based on the tag type. If the tag is determined to be a beneficiary-associated tag, the entity registration branch is followed to decision block 806. In block 806, a determination is made whether the system has previously processed the user and/or client device. If not previously processed, the no branch is followed to block 808 in which the user and/or client device is associated with the entity or beneficiary. Block 808 is followed by block 810, in which the user is presented with a list of participating merchants, and the method 800 may end.

Turning back to decision block 806, if a determination is made the system has previously processed the user and/or client device, the yes branch is followed to decision block 812. In block 812, a determination is made whether the client device is already associated with an entity or beneficiary. If not already associated, the no branch is followed to block 814, in which the user and/or client device is assigned to the entity or beneficiary. Block 814 is followed by block 816, in which the user is presented with a list of participating merchants, and the method 800 may end.

Turning back to decision block 821, if the client device is already associated with an entity or beneficiary, the yes branch is followed to block 818. In block 818, the user can be presented with a selectable user interface with options to either stay with the entity or beneficiary already assigned to the user and/or client device, or to switch to the entity or beneficiary associated with the recently or last scanned tag. Block 818 is followed by decision block 820, in which a user response is processed. If the user elects to switch, the switch branch is followed to block 822, in which the user and/or client device is associated with the new entity or beneficiary. Block 822 is followed by block 824, in which the user is presented with a list of participating merchants, and the method 800 may end.

Turning back to decision block 820, if the user elects to stay with the entity or beneficiary already assigned to the user and/or client device, the stick branch is followed to block 826. In block 826, the assignment of the entity or beneficiary with the user and/or client device is left as is. Block 826 is followed by block 828, in which the user is presented with a list of participating merchants, and the method 800 may end.

Turning back to decision block 804, if the tag is determined to be another type of tag, rather than a beneficiary-associated tag or a merchant-type tag, the other branch is followed to block 830. In block 830, the user is presented with an error message, and the method 800 may end.

Turning back to decision block 804, if the tag is determined to be a merchant-type tag, the merchant tag branch is followed to decision block 832. At block 832, a determination is made whether a valid scan has been made. If a valid scan is determined not to have been made, the no branch is followed to block 834, in which an invalid scan is recorded, the user is presented with an error message, and the method 800 may end.

Turning back to decision block 832, if a valid scan is determined to have been made, the yes branch is followed to decision block 836. In block 836, a determination is made whether the system has previously processed the user and/or client device. If a determination is made that the system has not previously processed the user and/or client device, the no branch is followed to decision block 838. In block 838, a determination is made whether the merchant is associated with multiple entities or beneficiaries. If the merchant is not determined to be associated with multiple entities or beneficiaries, the no branch is followed to block 840. In block 840, the user and/or client device is automatically assigned to the single entity associated with the merchant. Block 840 is followed by block 842, in which the scan is recorded on behalf of the entity or beneficiary. Block 842 is followed by block 844, in which the user is presented with a list of participating merchants, and the method 800 may end.

Turning back to decision block 838, if a determination is made that the merchant is associated with multiple entities or beneficiaries, the yes branch is followed to block 846. In block 846, a list of entities or beneficiaries associated with the merchant is presented to the user. Block 846 is followed by block 848, in which the user and/or device is assigned to the entity or beneficiary selected by the user. Block 848 is followed by block 850, in which the scan is recorded on behalf of the entity or beneficiary. Block 850 is followed by block 852, in which the user is presented with a list of participating merchants, and the method 800 may end.

Turning back to decision block 836, if the system is determined to have previously processed the user and/or client device, the yes branch is followed to block 854. In block 854, the entity or beneficiary currently associated with the user and/or client device is determined. Block 854 is followed by decision block 856, in which a determination is made whether the merchant is associated with the particular entity or beneficiary. If a determination is made the merchant is associated with the particular entity or beneficiary, the yes branch is followed to block 858. In block 858, the scan is recorded on behalf of the entity or beneficiary, and the method 800 may end.

Turning back to decision block 856, if a determination is made the merchant is not associated with the particular entity or beneficiary, the no branch is followed to block 860. In block 860, a selectable user interface can be output to the user to present options to either switch to an entity or beneficiary associated with the particular merchant, or credit another entity or beneficiary with the scanned tag. Block 860 is followed by decision block 862, in which the user response is processed, and a determination is made whether the user elected to switch or credit another entity or beneficiary. If a determination is made that the user elects to switch to an entity or beneficiary associated with the particular merchant, the switch branch is followed to block 864. In block 864, the user and/or client device is assigned to the entity or beneficiary selected by the user and/or client device. Block 864 is followed by block 866, in which the scan is recorded on behalf of the entity or beneficiary. Block 866 is followed by block 868, in which the user is presented with a list of participating merchants, and the method 800 may end.

Turning back to decision block 862, if a determination is made that the user elects to credit another entity or beneficiary with the scanned tag, the credit some other entity branch is followed to block 870. In block 870, the scan is recorded on behalf of the specified entity or beneficiary. Block 870 is followed by block 872, in which the user is presented with a list of participating merchants, and the method 800 may end.

The various methods described herein are by way of example, and can have fewer or greater numbers of operations, and/or may be performed in other sequences than described herein, according to embodiments of the disclosure.

While certain embodiments of the disclosure have been described in connection with what is presently considered to be the most practical and various embodiments, it is to be understood that the disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosure, including the best mode, and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed disclosure is:

1. A system, comprising:
a processor operable to execute computer-executable instructions stored in at least one memory;
the at least one memory operable to store a module with computer-executable instructions operable to:
receive an indication a merchant-associated tag was scanned by a tag reader via a processor-based device at a merchant location;
validate the merchant-associated tag and scanning event; and
provide an incentive to a beneficiary based at least in part on the validation of the merchant-associated tag and the scanning event.

2. The system of claim 1, wherein the merchant-associated tag comprises at least one of the following: a bar code, a 2D bar code, a Microsoft™ Tag, a QR code, or an alphanumeric code.

3. The system of claim 1, wherein the computer-executable instructions are further operable to:
output fundraising campaign information to the processor-based device.

4. The system of claim 1, wherein the computer-executable instructions operable to validate the merchant-associated tag and scanning event comprise computer-executable instructions further operable to perform at least one of the following:
compare geo-location information received from the processor-device with previously stored location information.

5. The system of claim 1, wherein the incentive comprises monetary compensation based at least in part on the merchant's actual revenue, sales, consumer traffic, or combination thereof.

6. The system of claim 1, wherein the computer-executable instructions are further operable to:
provide respective scannable tags to a merchant and a beneficiary, wherein the scannable tags uniquely identify the merchant and the beneficiary.

7. The system of claim 1, wherein the computer-executable instructions are further operable to:
provide a downloadable application for a processor-based device, wherein the application comprises the tag reader.

8. The system of claim 1, wherein the computer-executable instructions are further operable to:
receive an indication a beneficiary-associated tag was scanned by a tag reader via the processor-based device; and
associate the processor-based device with the beneficiary.

9. A method comprising:
receiving an indication a merchant-associated tag was scanned by a tag reader via a processor-based device at a merchant location;
validating the merchant-associated tag and scanning event; and
providing an incentive to a beneficiary based at least in part on the validation of the merchant-associated tag and the scanning event.

10. The method of claim 9, wherein the merchant-associated tag comprises at least one of the following: a bar code, a 2D bar code, a Microsoft™ Tag, a QR code, or an alphanumeric code.

11. The method of claim 9, further comprising:
outputting fundraising campaign information to the processor-based device.

12. The method of claim 9, wherein validating the merchant-associated tag and scanning event comprises at least one of the following:
comparing geo-location information received from the processor-device with previously stored location information.

13. The method of claim 9, wherein the incentive comprises monetary compensation based at least in part on the merchant's actual revenue, sales, consumer traffic, or combination thereof.

14. The method of claim 9, further comprising:
providing a scannable tag to a merchant, wherein the scannable tag uniquely identifies the merchant and at least one beneficiary.

15. The method of claim 9, further comprising:
providing a downloadable application for a processor-based device, wherein the application comprises the tag reader.

16. The method of claim 9, further comprising:
receiving an indication a beneficiary-associated tag was scanned by a tag reader via the processor-based device; and
associating the processor-based device with the beneficiary.

17. One or more computer-readable media storing computer-executable instructions that, when executed by at least one processor, configure the at least one processor to:
receive an indication a merchant-associated tag was scanned by a tag reader via a processor-based device at a merchant location;
validate the merchant-associated tag and scanning event; and
provide an incentive to a beneficiary based at least in part on the validation of the merchant-associated tag and the scanning event.

18. The one or more computer-readable media of claim 17, further comprising computer-executable instructions to:
compare geo-location information received from the processor-device with previously stored location information associated with the merchant.

19. The one or more computer-readable media of claim 17, further comprising computer-executable instructions to:
receive an indication a beneficiary-associated tag was scanned by a tag reader via the processor-based device; and
associate the processor-based device with the beneficiary.

20. The one or more computer-readable media of claim 17, wherein the incentive comprises monetary compensation based at least in part on the merchant's actual revenue, sales, consumer traffic, or combination thereof.
